(19) United States
(12) Patent Application Publication
(10) Pub. No.: US 2019/0102054 A1
(43) Pub. Date: Apr. 4, 2019

(54) SYSTEMS AND METHODS FOR ENABLING PARTICIPANTS IN AN AUDIO OR VIDEO CONFERENCE SESSION TO EXPRESS INTEREST IN SHARED CONTENT

(71) Applicant: RingCentral, Inc., Belmont, CA (US)

(72) Inventor: Dmitry Pevzner, Saint-Petersburg (RU)

(73) Assignee: RingCentral, Inc.

(21) Appl. No.: 15/821,643

(22) Filed: Nov. 22, 2017

Related U.S. Application Data
(63) Continuation-in-part of application No. PCT/RU2017/000720, filed on Sep. 29, 2017.

(51) Int. Cl. G06F 3/0484; H04L 12/58; H04L 29/06; H04N 7/15

(52) U.S. Cl. CPC G06F 3/0484; H04L 51/20; H04N 7/15; H04L 65/601; H04L 65/403; H04L 65/4015

(57) ABSTRACT

The present disclosure relates to systems and methods for enabling participants in a communications session having shared content to express an interest in the shared content. In one implementation, the system may include a memory storing instructions and a processor configured to execute the instructions. The instructions may comprise instructions to receive an indication that a participant has expressed interest in the shared content, determine a location of the shared content associated with the received indication, and send a notification to at least one of the other participants about the expressed interest and the determined location of the shared content. Accordingly, other participants may receive a more precise notification than in previous systems.

### CROSS-REFERENCE TO RELATED APPLICATIONS

This application is a continuation-in-part of International Application No. PCT/RU2017/000720, with an international filing date of Sep. 29, 2017, the contents of which are incorporated herein by reference.

### TECHNICAL FIELD

The present disclosure relates generally to communications sessions in audio or video conferencing. More specifically, and without limitation, this disclosure relates to systems and methods for enabling participants in a communications session having shared content to express an interest in the shared content.

### BACKGROUND

In a communications session, such as an audio and/or video conference, participants may share content amongst themselves. For example, one participant may share a screen such that other participants see an image of the shared screen. During the communications session, a participant may also express an interest in discussing the shared content. However, many extant systems offer no option for the participant to express his or her interest without verbally interrupting the flow of the communications session.

### SUMMARY

In view of the foregoing, embodiments of the present disclosure provide systems and methods for enabling participants in a communications session having shared content to express an interest in the shared content. In accordance with some embodiments, a generated notification may include a determined location within the shared content to which the interest is directed. Accordingly, a detailed indicator of interest is distributed amongst a plurality of participants in a video or audio conference, without any verbal interruption in the communications session.

According to an example embodiment of the present disclosure, a system for enabling participants in a communications session having shared content to express an interest in the shared content is described. The system may comprise a memory storing instructions and a processor configured to execute the instructions. The instructions may comprise instructions to receive an indication that a participant has expressed interest in the shared content, determine a location of the shared content associated with the indication or corresponding to the interest, and send a notification to at least one of the other participants about the expressed interest and the determined location of the shared content.

In some embodiments, the at least one processor may be further configured to receive at least one set of coordinates local to a screen associated with the participant. In certain aspects, the instructions to determine the location may further comprise instructions to convert the local set of coordinates to a global set of coordinates.

In some embodiments, the at least one processor may be further configured to receive at least one image or cropped image representative of an area of interest of a screen associated with the participant. In certain aspects, the instructions to determine the location may further comprise instructions to extract the location from the at least one image.

In some embodiments, the instructions to send the notification may further comprise instructions to modify the shared content to include the determined location. In certain aspects, the shared content may include at least one image, and the instructions to modify the shared content may further comprise instructions to modify the at least one image.

In some embodiments, the notification may further comprise a sound. In some embodiments, the indication may be received using a network interface controller. In some embodiments, the notification may be sent using a network interface controller.

According to another example embodiment of the present disclosure, a method for enabling participants in a communications session having shared content to express an interest in the shared content users is described. The method may comprise receiving an indication that a participant has expressed interest in the shared content, determining a location of the shared content associated with the indication, and sending a notification to at least one of the other participants about the expressed interest and the determined location of the shared content.

In some embodiments, the method may further comprise receiving at least one set of coordinates local to a screen associated with the participant. In certain aspects, determining the location may further comprise converting the local set of coordinates to a global set of coordinates.

In some embodiments, the method may further comprise receiving at least one image representative of a screen associated with the participant. In certain aspects, determining the location may further comprise extracting the location from the at least one image.

In some embodiments, sending the notification may further comprise modifying the shared content to include the determined location. In certain aspects, the shared content may include at least one image, and modifying the shared content may further comprise modifying the at least one image.

According to yet another example embodiment of the present disclosure, a non-transitory computer-readable medium storing instructions for enabling participants in a communications session having shared content to express an interest in the shared content users is described. The instructions, when executed by at least one processor, may cause the at least one processor to receive an indication that a participant has expressed interest in the shared content, determine a location of the shared content associated with the indication, and send a notification to at least one of the other participants about the expressed interest and the determined location of the shared content.

In some embodiments, the instructions may further cause the at least one processor to receive at least one set of coordinates local to a screen associated with the participant and convert the local set of coordinates to a global set of coordinates. In some embodiments, the instructions may further cause the at least one processor to receive at least one image representative of a screen associated with the participant and extract the location from the at least one image.

It is to be understood that the foregoing general description and the following detailed description are example and explanatory only, and are not restrictive of the disclosed embodiments.

### BRIEF DESCRIPTION OF THE DRAWINGS

The accompanying drawings, which comprise a part of this specification, illustrate several embodiments and, together with the description, serve to explain the principles disclosed herein. In the drawings:

FIG. 1 is a block diagram of an example system for initiating and conducting a communications session with a plurality of participants.

FIG. 2A is a diagram of an example graphical user interface for enabling participants in a communications session having shared content to express an interest in the shared content, according to an example embodiment of the present disclosure.

FIG. 2B is a diagram of another example graphical user interface for enabling participants in a communications session having shared content to express an interest in the shared content, according to an example embodiment of the present disclosure.

FIG. 3 is a flowchart of an example method for enabling participants in a communications session having shared content to express an interest in the shared content, according to an example embodiment of the present disclosure.

FIG. 4 is a flowchart of another example method for enabling participants in a communications session having shared content to express an interest in the shared content, according to an example embodiment of the present disclosure.

FIG. 5A is an illustration of an example conferencing system capable of executing the example method of FIG. 2.

FIG. 5B is an illustration of another example conferencing system capable of executing the example method of FIG. 2.

FIG. 6 is a block diagram of an example computing device with which the systems, methods, and apparatuses of the present invention may be implemented.

### DETAILED DESCRIPTION

The disclosed embodiments relate to systems and methods for enabling participants in a communications session having shared content to express an interest in the shared content. Embodiments of the present disclosure may be implemented using a general-purpose computer. Alternatively, a special-purpose computer may be built according to embodiments of the present disclosure using suitable logic elements.

Advantageously, disclosed embodiments allow for providing discreetly a notification of an expressed interest in content shared in a communications session. Additionally, embodiments of the present disclosure allow for including a determined location in the notification, which may provide a detailed notice to participants of the communications session of a portion of the shared content associated with the expressed interest.

According to an aspect of the present disclosure, a communications session may have a plurality of participants and shared content in a conference. In some embodiments, the conference may be an audio conference session. Optionally, the conference may also include video.

Each of the plurality of participants may use one or more user interface devices to connect to the communications session. For example, a user interface device may comprise a laptop computer, a desktop computer, a smartphone, a tablet, or any other device capable of receiving audio and/or video and transmitting it to a collaboration server. As used herein, the term “collaboration server” refers to one or more servers (which may reside on one or more server farms or server clusters) executing one or more applications to facilitate a communications session.

In certain aspects, a plurality of participants may share one or more user interface devices. For example, a plurality of participants may connect to the communications session using a single computer within a conference room. Alternatively, a participant may use a user interface device without sharing. For example, a participant may use a tablet or a smartphone for connecting to the communications session.

In certain aspects, the shared content may comprise the contents of a screen of a user interface device that is being shared with other participants in the communications session. For example, a participant may activate the “share screen” feature of an application connected to the communications session, thereby sending an image of all or part of the participant's screen to other participants in the session. By way of further example, a participant may share a presentation such as a Microsoft® Powerpoint presentation, thereby sending slides of the presentation to other participants in the session.

According to an aspect of the present disclosure, at least one processor may receive an indication that a participant in a conference having a communications session established among participants has expressed interest in a shared content. The participant may be connected to the communications session using one or more user interface devices. For example, a user interface device may comprise a smartphone, a tablet, a laptop computer, a desktop computer, or any other device capable of sending and receiving media (such as audio, video, text, or the like) over a computer network. In certain aspects, a plurality of participants may use a single user interface device to connect to the communications session. For example, more than one participant may be located in a conference room or other shared location and may connect to the communications session using a single user interface device in the shared location. Accordingly, as used herein, the term “participant” may refer to a single user connected to the communications session via one or more user interface devices or to a plurality of users connected to the communications session with a shared user interface device in a conference.

In some embodiments, the processor receives the indication from the participant via the one or more user interface devices associated with the participant. For example, the participant may generate the indication using one or more preconfigured functions. In an example in which the user interface device is a laptop or desktop computer (or a tablet with a mouse or touchpad), the participant may left click, right click, double click, or the like to generate the indication. In an example in which the user interface has a touchscreen, the participant may tap, double tap, draw, press, press-and-hold, or the like to generate the indication. In yet another example, the participant may navigate a cursor, pointer, or stylus to the location of interest, and then activate the indication function at the location. In a general example, the participant may click, tap, or otherwise activate a button to generate the indication or may drag-and-drop an icon onto an area to generate the indication.

In some embodiments, the processor may receive the indication using a network interface controller (NIC). For example, the user interface device used to generate the indication may send the indication to the at least one processor over a computer network. In such an example, the user interface device may use at least one NIC to send the indication, and the processor may use at least one different NIC to receive the sent indication. The NICs may communication over at least one computer network, such as the Internet, a local area network (LAN), or the like.

According to an aspect of the present disclosure, the processor may determine a location of the shared content associated with the indication. In some embodiments, determining the location may comprise receiving the location. For example, the processor may receive coordinates relating to the location with the indication. In such an example, the user interface device used to generate the indication may determine the location based on the generation of the indication. For example, if the participant uses a left click, right click, double click, tap, double tap, drag-and-drop, or the like to generate the indication, the user interface device may determine the location based on the location of the click, tap, drag-and-drop, etc.

In a different example, the processor may receive the location separately from the indication. For example, the user interface device used to generate the indication may send the indication before (or after) the location. By way of further example, the user interface device used to generate the indication may send the indication using a separate computer network from that used to send the location, which may be sent before, after, or concurrently with the indication.

In some embodiments, the processor may further receive at least one set of coordinates local to a screen associated with the participant. For example, the screen associated with the participant may comprise a screen of the user interface device(s) associated with the participant. In such embodiments, the processor may convert the local set of coordinates to a global set of coordinates.

In certain aspects, the user interface device(s) associated with the participant may send information regarding the screen to the at least one processor. Accordingly, the processor may use the received information regarding the screen to transform the local set of coordinates to a global set of coordinates. In some examples, the information may comprise one or more transformation matrices for transforming the local set of coordinates. In other example, the information may comprise one or more properties of the screen (such as the center of the screen in global coordinates, one or more scaling factors for a dimension of the screen as compared to the global coordinate system, etc.) from which the at least one processor may determine one or more transformation matrices.

Alternatively or concurrently, the user interface device(s) associated with the participant may convert the local set of coordinates to a global set of coordinates prior to sending the coordinates to the at least one processor. That is, the processor may further receive at least one set of global coordinates.

In some embodiments, the processor may receive at least one image representative of a screen associated with the participant. For example, the screen associated with the participant may comprise a screen of the user interface device(s) associated with the participant. Moreover, the image may comprise a screenshot (or a portion of a screenshot) of the screen at a particular moment in time (e.g., the moment when the indication was generated, the moment when the location was determined, etc.).

In such embodiments, the processor may extract the location from the at least one image. For example, the processor may determine at least one set of coordinates associated with the generated indication. In such an example, the processor may identify a cursor, pointer, or other visual indication on the at least one image and determine the at least one set of coordinates based on the location of the cursor, pointer, stylus, or the like.

According to an aspect of the present disclosure, the processor may send a notification to at least one other participant about the expressed interest and the determined location of the shared content. For example, the notification may comprise a visual indicator of the determined location.

In some embodiments, the notification may further comprise a sound. For example, a chime, ring, tone, or other noise may be sent to at least one other participant as an indicator of the expressed interest. Upon receipt of the sound, a user interface device (or devices) associated with the at least one other participant may play the sound using one or more speakers of the user interface device.

In some embodiments, sending the notification may further comprise modifying the shared content to include the determined location. For example, if the shared content includes an image, the processor may modify the image. In such an example, the modification may include a visual indicator (such as a star or other static shape, a flashing or moving indicator, or the like) incorporated into the shared content. The shared content may thereafter be transmitted to the at least one other participant.

In some embodiments, the processor may send the notification using a network interface controller (NIC). For example, a user interface device associated with at least one other participant may receive the notification from the at least one processor over a computer network. In such an example, the processor may use at least one NIC to send the notification, and the user interface device may use at least one different NIC to receive the sent notification. The NICs may communication over at least one computer network, such as the Internet, a local area network (LAN), or the like.

In some embodiments, the processor may send another notification when an indication has been cleared. For example, the participant that generated the indication, a host of the communications session, or another participant in the communications session may clear the indication. In such embodiments, in response to the clearing of the indication, the processor may revert the shared content to a previous version, e.g., by removing the visual or other indicator previously sent.

In some embodiments, the processor may receive a plurality of indications, whether from a single participant or a plurality of participants. In such embodiments, the processor may send sequential notifications For example, the sequence of notifications may match the sequence in which the indications were received. Moreover, the processor may further clear notifications based on the sequence in which the indications were received. Alternatively or concurrently, as explained above, the processor may clear the notifications based on a sequence in which the indications are cleared.

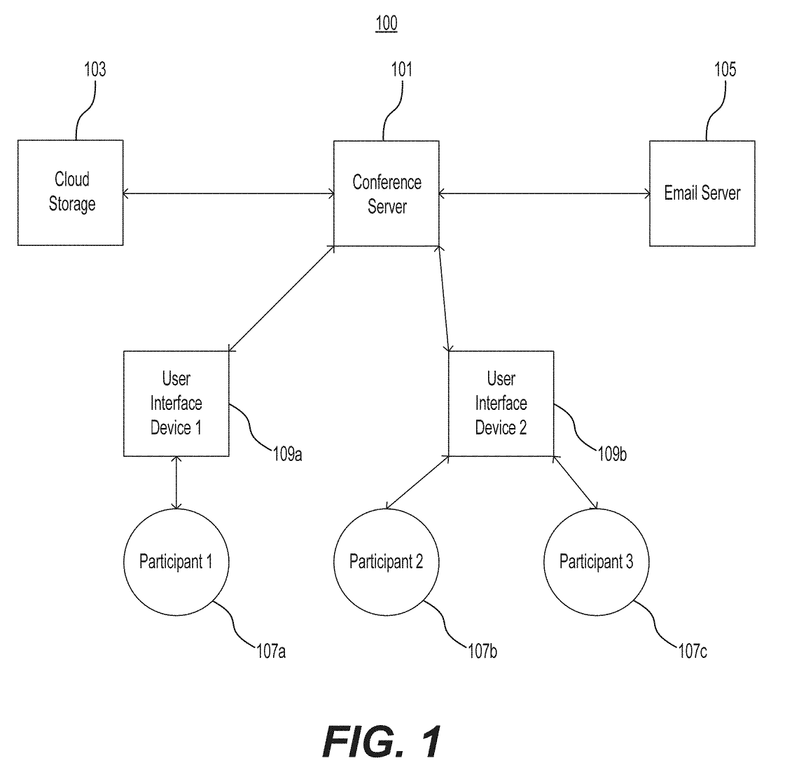

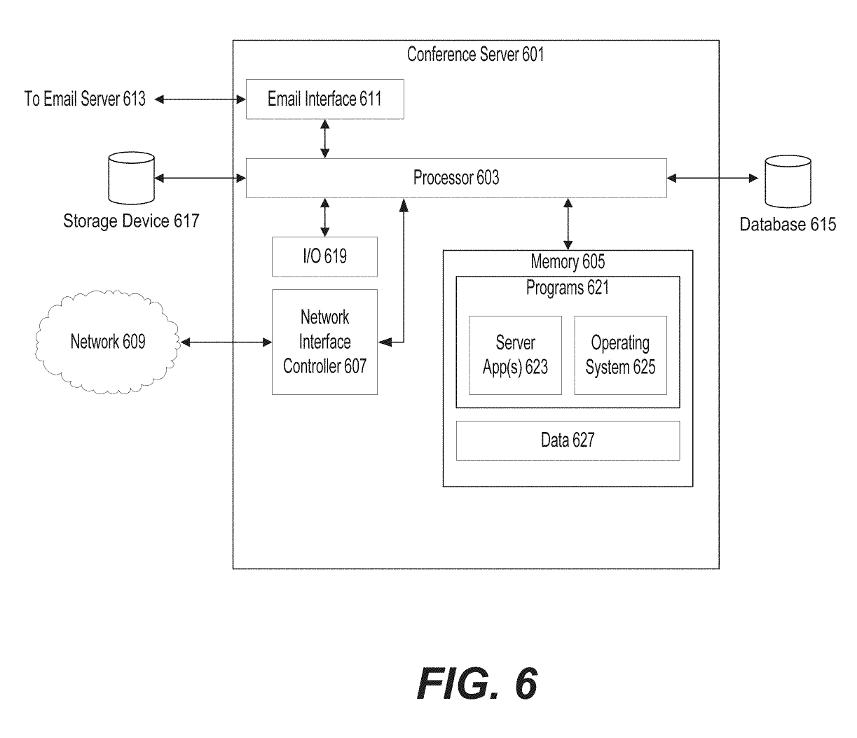

Turning now to FIG. 1, there is shown a system 100 for initiating and conducting a communications session with a plurality of participants. As depicted in FIG. 1, system 100 may include a conference server 101. Conference server 101 may, for example, comprise one or more of conference server 601 of FIG. 6. The one or more servers comprising conference server 101 may be housed on one or more server farms and/or server clusters.

In some embodiments, conference server 101 may be operably connected to cloud storage 103 and/or email server 105. Although depicted as single elements in FIG. 1, cloud storage 103 and/or email server 105 may comprise one or more servers (e.g., similar to conference server 601 of FIG. 6), which may be housed on one or more server farms and/or server clusters.

In the example of FIG. 1, participant 107a is connected to conference server 101 via user interface device 109a. For example, participant 107a may be connected via user interface device 109a available at a smartphone, tablet, laptop computer, desktop computer, or the like. As further depicted in the example of FIG. 1, participants 107b and 107c are connected to conference server 101 via user interface device 109b. For example, participants 107b and 107c may share a desktop computer or other computing device (which may be located in a shared location such as a conference room) to connect to conference server 101.

Accordingly, conference server 101 may manage a communications session between participants 107a, 107b, and 107c. For example, the communications session may support the exchange of video and/or audio between participants 107a, 107b, and 107c. By way of further example, the communications session may support the exchange of chat messages between participants 107a, 107b, and 107c and/or the display of shared content to participants 107a, 107b, and 107c. Such shared content may originate from user interface device 109a or 109b and/or from cloud storage 103. In addition to supporting chat messages, conference server 101 may permit participants 107a, 107b, and 107c to exchange email messages using email server 105. Furthermore, conference server 101 may manage notifications based on indications of expressed interests from participants 107a, 107b, and 107c.

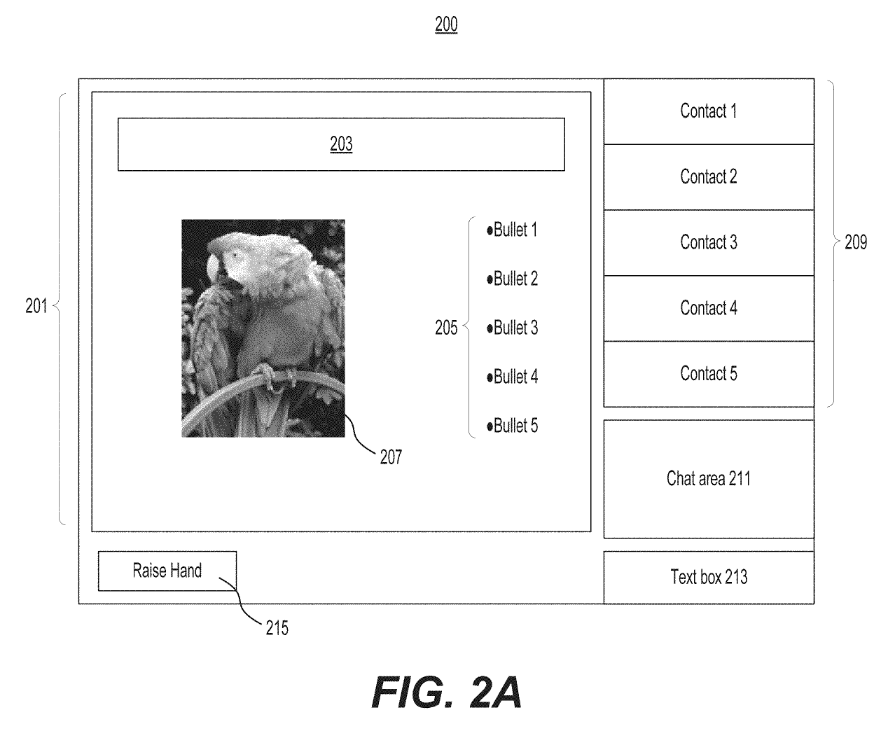

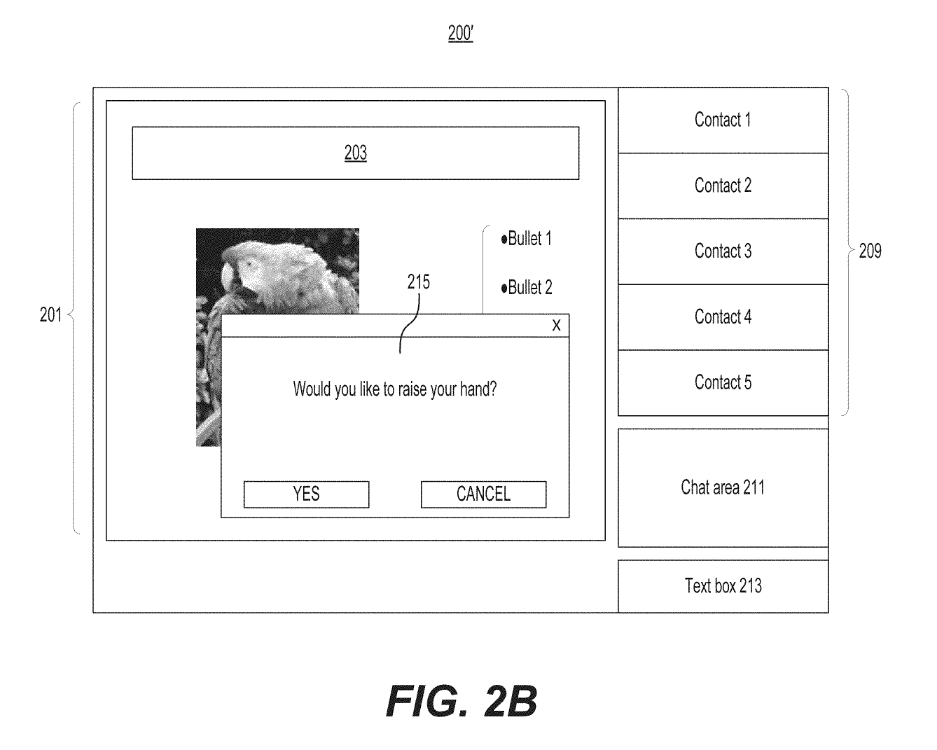

FIG. 2A depicts an example graphical user interface (GUI) 200 for enabling participants in a communications session having shared content to express an interest in the shared content. For example, GUI 200 may be displayed on a user interface device 109 associated with one or more participants

GUI 200 includes shared content 201. As depicted in the example of FIG. 2A, shared content 201 may include text (e.g., title 203 and bullet points 205), one or more graphics (e.g., image 207), or other audio visual media, such as a video clip, sound clip, interactive chart, or the like, or graphical representations thereof (not shown) shared amongst the participants in the communications session.

As further depicted in the example of FIG. 2A, GUI 200 may include a participant list 209, optionally coupled with a chat area 211 configured to display chat messages from the participants (e.g., one or more contacts listed in participant list 209) and a text box 213 configured to receive chat messages from a user of GUI 200 (who may also be a participant of the communications session).

The example of FIG. 2A depicts a button 215 (labeled “Raise Hand” in this example) that allows a user of GUI 200 to express an interest in shared content 201. For example, button 215 may result in sending an indication that a user of GUI 200 has expressed interest in shared content 201 to at least one processor of one or more servers hosting the communications session (e.g., server 601 of FIG. 6). Although not depicted in FIG. 2A, button 215 may also be dragged by a user of GUI 200 and dropped on a location on shared content 201. This action may result in sending an indication that a user of GUI 200 has expressed interest in shared content 201 along with the location on shared content 201 to at least one processor of one or more servers hosting the communications session (e.g., server 601 of FIG. 6).

Although not depicted in FIG. 2A, GUI 200 may further include a timeline or other visual representation of time on which the notification may be placed. For example, upon receipt of an indication of expressed interest, the processor may generate a visual indicator of the indication on the visual representation of time based on the time of generation and/or time of receipt of the indication. The processor may do so alternatively to or concurrently with another indicator, visual or otherwise, of the determined location associated with the indication. Furthermore, the processor may clear indicators on the visual representation of time similarly to clearing other indicators, as discussed above.

FIG. 2B depicts another example graphical user interface (GUI) 200′ for enabling participants in a communications session having shared content to express an interest in the shared content. For example, GUI 200′ may be displayed on a user interface device associated with one or more participants.

GUI 200′ includes shared content 201. Similar to the example of FIG. 2A, the example of FIG. 2B depicts shared content 201 with text, e.g., title 203 and bullet points 205 (partially obscured) and one or more images, e.g., image 207 (partially obscured).

Similar to the example of FIG. 2A, GUI 200′ may include a participant list 209, optionally coupled with a chat area 211 configured to display chat messages from the participants (e.g., one or more listed in participant list 209) and a text box 213 configured to receive chat messages from a user of GUI 200′ (who may also be a participant of the communications session).

The example of FIG. 2B depicts a separate window 215 asking a user of GUI 200′ to confirm that they are expressing an interest in shared content 201. In some embodiments, window 215 may be presented after a user of GUI 200′ clicks, taps, or otherwise selects a location or an area on shared content 201. For example, a user may right click or double tap on a location on shared content 201 and be presented with window 215 asking for confirmation. Upon confirmation, an indication that a user of GUI 200′ has expressed interest in shared content 201 may be sent to at least one processor of one or more servers hosting the communications session (e.g., server 601 of FIG. 6). Furthermore, the location on shared content 201 on which a user of GUI 200′ has clicked, tapped, or otherwise selected may be sent to at least one processor of one or more servers hosting the communications session (e.g., server 601 of FIG. 6).

Although depicted in FIG. 2B with window 215, GUI 200′ may allow for sending the indication and/or the location with receiving confirmation, that is, without displaying window 215.

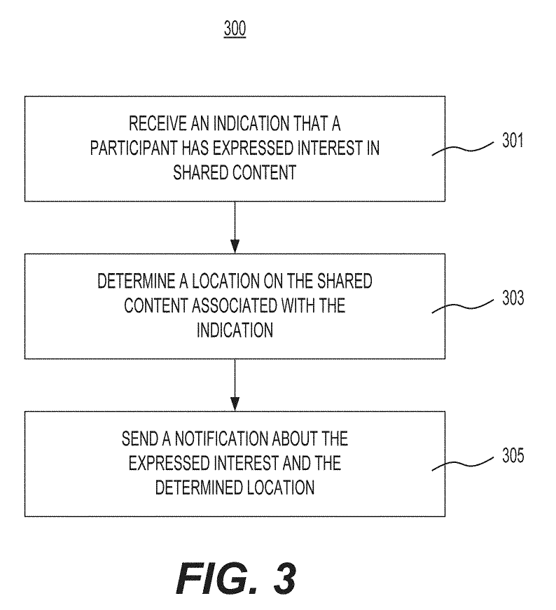

FIG. 3 is a flowchart of example method 300 for enabling participants in a communications session having shared content to express an interest in part or all of the shared content. Method 300 may be implemented using a general-purpose computer including at least one processor, e.g., server 601 of FIG. 6. Alternatively, a special-purpose computer may be built for implementing method 300 using suitable logic elements.

At step 301, a processor receives an indication that a participant has expressed interest in the shared content. For example, the processor may receive the indication from the participant via one or more user interface devices (e.g., a smartphone, a tablet, a desktop computer, a laptop computer, etc.) associated with the participant. The participant may generate the indication using one or more preconfigured functions, such as a left click, a right click, a double click, a tap, a double tap, selection of an area, or the like. In another example, the participant may click, tap, or otherwise activate a button to generate the indication or may drag-and-drop an icon onto an area to generate the indication.

At step 303, the processor determines a location of the shared content associated with the indication. For example, determining the location may comprise receiving the location. In some embodiments, as explained above, the processor may receive the location with the indication. In other embodiments, as explained above, the processor may receive the location separately from the indication.

In some embodiments, the processor may further receive at least one set of coordinates local to a screen associated with the participant. For example, the screen associated with the participant may comprise a screen of the user interface device(s) associated with the participant. In such embodiments, determining the location may comprise converting the local set of coordinates to a global set of coordinates.

In certain aspects, the user interface device(s) associated with the participant may send information regarding the screen to the processor. Accordingly, as explained above, the processor may use the received information regarding the screen to transform the local set of coordinates to a global set of coordinates.

Alternatively or concurrently, the user interface device(s) associated with the participant may convert the local set of coordinates to a global set of coordinates prior to sending the coordinates to the processor. That is, determining the location may comprise receiving at least one set of global coordinates.

In some embodiments, the processor may receive at least one image representative of a screen associated with the participant. For example, the image may comprise a screenshot (or a portion of a screenshot) of the screen at a particular moment in time (e.g., the moment when the indication was generated, the moment when the location was determined, etc.). In such embodiments, determining the location may comprise extracting the location from the at least one image.

At step 305, the processor sends a notification to at least one of the other participants about the expressed interest and the determined location of the shared content. For example, the notification may comprise a visual indicator of the determined location.

In some embodiments, the notification may further comprise a sound. For example, a chime, ring, tone, or other noise may be sent to the at least one of the other participants as an indicator of the expressed interest. Upon receipt of the sound, a user interface device (or devices) associated with the at least one of the other participants may play the sound using one or more speakers of the user interface device.

Method 300 may further include additional steps. For example, processor may receive a subset of participants having access to the shared content. Alternatively or concurrently, the processor may receive a subset of participants having access to the notification. In embodiments having both subsets, subset of participants having access to the notification may be of equal size or small than the subset of participants having access to the shared content.

Accordingly, the processor may determine the at least one of the other participants based on at least one of a subset of participants having access to the shared content and a subset of participants having access to the notification. The subset of participants having access to the shared content may be determined by one or more owners of the shared content, one or more hosts of the communications session, one or more other participants, or a combination thereof. The subset of participants having access to the notification may be determined by the participant who expressed interest, one or more hosts of the communications session, one or more other participants, or a combination thereof.

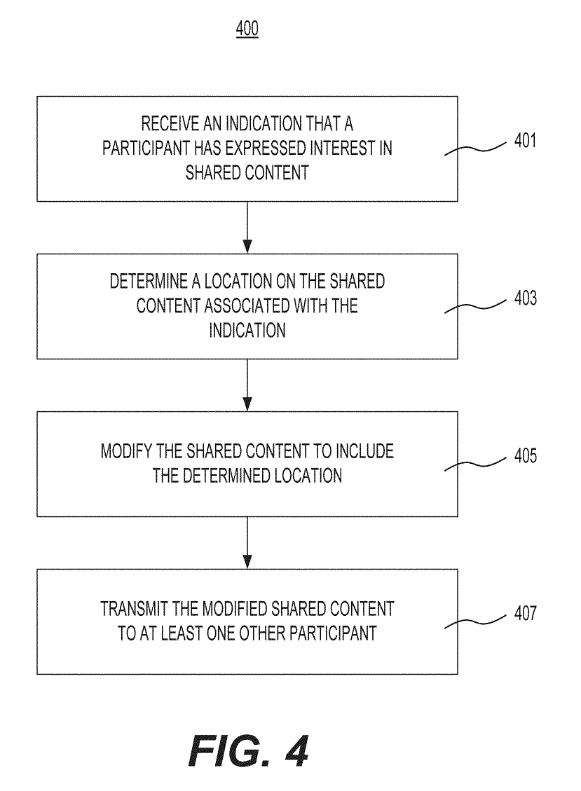

FIG. 4 is a flowchart of another example method 400 for enabling participants in a communications session having shared content to express an interest in all or part of the shared content. Method 400 may be implemented using a general-purpose computer including at least one processor, e.g., server 601 of FIG. 6. Alternatively, a special-purpose computer may be built for implementing method 400 using suitable logic elements.

At step 401, a processor receives an indication that a participant has expressed interest in the shared content. For example, step 401 may be similar to step 301 of method 300 of FIG. 3, described above.

At step 403, the processor determines a location of the shared content associated with the indication. For example, step 403 may be similar to step 303 of method 300 of FIG. 3, described above.

At step 405, the processor modifies the shared content to include the determined location. For example, if the shared content includes at least one image, and the processor may modify the at least one image. In such an example, the modification may include a visual indicator (such as a star or other static shape, a flashing or moving indicator, or the like) incorporated into the shared content. The shared content may thereafter be transmitted to the at least one other participant.

At step 407, the processor transmits the modified shared content to at least one of the other participants. For example, the processor may replace the shared content with the modified shared content for the at least one of the other participants.

Method 400 may further include additional steps. For example, the processor may receive a subset of participants having access to the shared content. Alternatively or concurrently, the processor may receive a subset of participants having access to the modified shared content. In embodiments having both subsets, subset of participants having access to the modified shared content may be of equal size or small than the subset of participants having access to the shared content.

Accordingly, the processor may determine the at least one of the other participants based on at least one of a subset of participants having access to the shared content and a subset of participants having access to the modified shared content. The subset of participants having access to the shared content may be determined by one or more owners of the shared content, one or more hosts of the communications session, one or more other participants, or a combination thereof. The subset of participants having access to the modified shared content may be determined by the participant who expressed interest, one or more hosts of the communications session, one or more other participants, or a combination thereof.

By way of further example, the processor may transmit a notification in addition to or alternatively to the modified shared content. In such an example, the notification may comprise a visual indicator overlaid on or juxtaposed with the shared content and/or may comprise a sound, as described above with respect to step 305 of method 300 of FIG. 3.

Methods 300 and 400 may be combined in various ways. For example, steps 405 and 407 of method 400 may be executed alternatively to or concurrently with step 305 of method 300.

In some embodiments, method 300 and/or method 400 may further include storing the received indication in a queue or other database. For example, the queue may be configured to be first-in-first-out, last-in-first-out, a priority queue (e.g., indications received from a host of the communications session have priority over indications received from other participants), or a custom configuration. Concurrently, the processor may send a notification when an indication leaves to queue to at least one of the other participants or may modify the shared content to remove an indicator of the removed indication and transmit the modified shared content to at least one of the other participants. For example, the notification may comprise a removal of the previous visual indicator and/or a sound, etc.

As another example, the processor may remove the stored indication from the queue upon receiving a clearing command from a participant. For example, the participant may comprise the participant who generated the indication, a host of the communications session, or another participant in the communications session. Concurrently, as explained above, the processor may send a notification of the removing of the indication to at least one of the other participants or may modify the shared content to remove an indicator of the removed indication and transmit the modified shared content to at least one of the other participants. For example, the notification may comprise a removal of the previous visual indicator and/or a sound, etc.

In some embodiments, method 300 and/or method 400 may further include storing the indication. For example, the indication may be stored along with a time of generation and/or time of receipt. Accordingly, in embodiments where the communications session is recorded, such recording may include or be linked to the stored indication. For example, if the recording is listened to or viewed, the indication may be displayed or heard or otherwise incorporated into the playback of the recording.

In some embodiments, method 300 and/or method 400 may further include receiving a participant to associate with the received indication. The associated participant may be received concurrently with the indication in step 301 and/or step 401 or may be received separately. In such embodiments, the notification may further include the associated participant. For example, the notification may comprise a visual indicator of the determined location coupled (via juxtaposition, color coordination, or the like) with a visual indicator of the associated participant. Such notifications may be removed if an indication is clear, as described above.

In some embodiments, method 300 and/or method 400 may further include receiving a task to associate with the received indication. For example, the participant who generated the indication may also send to the processor, concurrently with or separately from the indication, the associated task. Alternatively or concurrently, a host of the communications session (or other participant) may send the associated task in response to a notification of the received indication. For example, after receiving the notification of about the expressed interest, a participant may send a task to the processor for association with the indication of the express interest and/or with one or more participants. The associated participant may comprise the participant who generated the expressed interest and/or another participant. Moreover, the task may be cleared or removed similar to the indications, as described above.

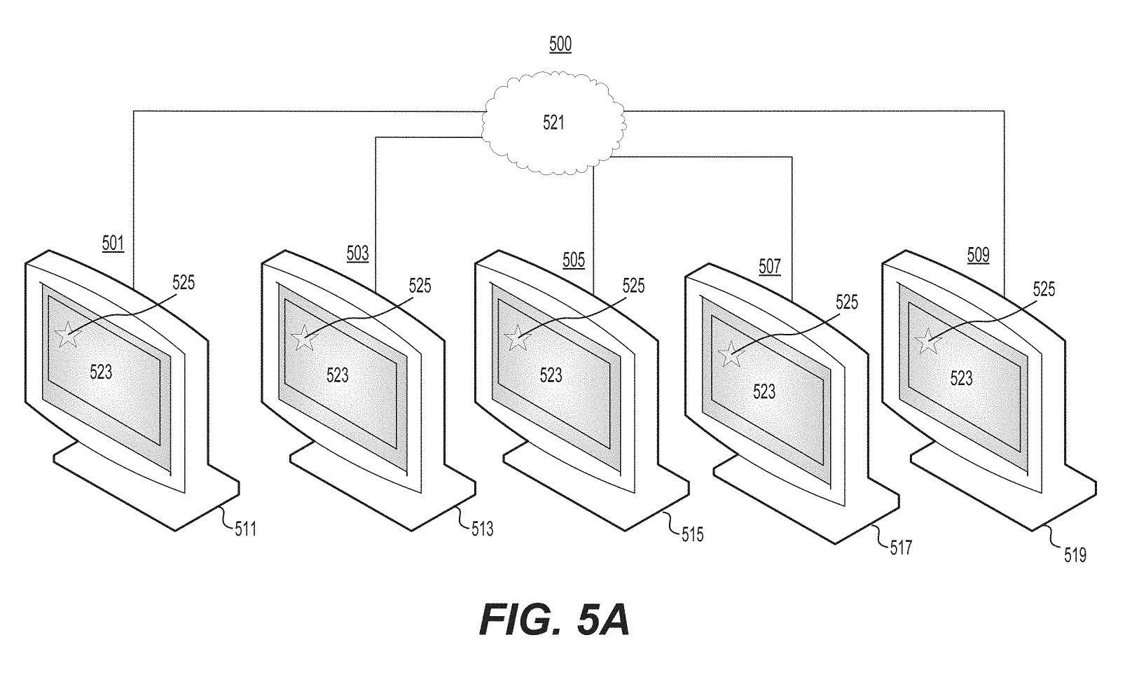

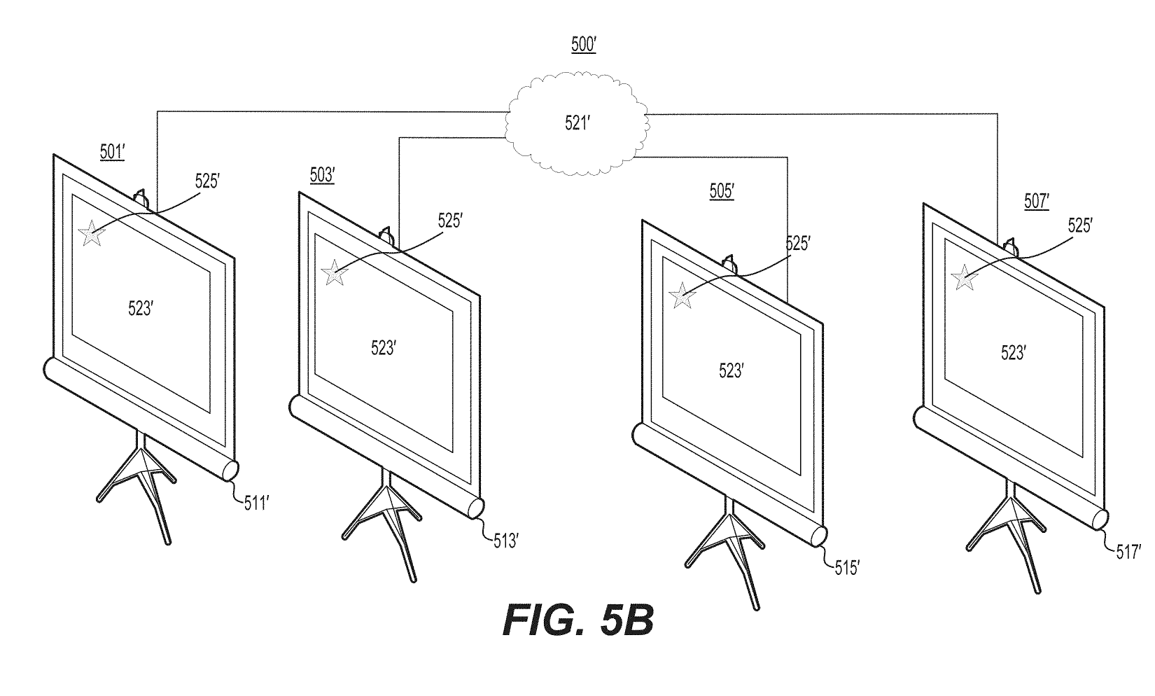

FIG. 5A is an illustration of an example conferencing system 500 capable of executing example method 300 of FIG. 3 and/or method 400 of FIG. 4. As depicted in FIG. 5A, system 500 includes a plurality of participants, e.g., participants 501, 503, 505, 507, and 509, participating in a communications session.

In the example of FIG. 5A, participants 501, 503, 505, 507, and 509 each comprise one person accessing the communications session via an individual user interface device. For example, participants 501, 503, 505, 507, and 509 may participate in the communications session via user interface devices 511, 513, 515, 517, and 519, which are connected via network 521. Although depicted as desktop computers in FIG. 5A, one or more of user interface devices 511, 513, 515, 517, and 519 may alternatively comprise a laptop computer, a tablet, a smartphone, or the like.

User interface devices 511, 513, 515, 517, and 519 may each include a processor and memory (not shown). User interface devices 511, 513, 515, 517, and 519 may further include peripherals such as displays, speakers, microphones, cameras, keyboards, mice, etc. (not shown). Network 521 may comprise a local access network (LAN), an intranet, the Internet, etc. Network 521 may further connect to one or more conferencing servers, e.g., conference server 601 of FIG. 6, that manage the communications session between the plurality of participants.

In the example of FIG. 5A, the memories of user interface devices 511, 513, 515, 517, and 519 include communications session software such that shared content 523 is displayed to each participant. Shared content 523 may be stored on one or more of user interface devices 511, 513, 515, 517, and 519. Alternatively or concurrently, shared content 523 may be stored on a remote server, e.g., cloud storage 103 of FIG. 1 (not shown in FIG. 5A).

In the example of FIG. 5A, example method 300 of FIG. 3 (and/or example method 400 of FIG. 4) is executed by the conference server. Accordingly, as depicted in FIG. 5A, notification 525 is displayed on shared content 523 for each participant. Although depicted as a visual modification to shared content 523 in FIG. 5A, notification 525 may alternatively or concurrently comprise a textual indication of a location on shared content 523, a visual indication of a location on shared content 523 yet separate therefrom, a sound, or a combination thereof.

Although FIG. 5A depicts shared content 523 as shown to each participant, in some embodiments, shared content 523 may only be shared with (and, accordingly, displayed) to a subset of participants. Similarly, although FIG. 5A depicts notification 525 as shown to each participant, in some embodiments, notification 525 may only be sent (and, accordingly displayed) to a subset of participants.

FIG. 5B is an illustration of example conferencing system 500′ capable of executing example method 300 of FIG. 3 and/or method 400 of FIG. 4. As depicted in FIG. 5B, system 500′ includes a plurality of participants, e.g., participants 501′, 503′, 505′, and 507′ participating in a communications session.

In the example of FIG. 5B, participants 501′, 503′, 505′, and 507′ each comprise one or more people accessing the communications session via a group conference system. For example, participants 501′, 503′, 505′, and 507′ may participate in the communications session via conference room systems, e.g., systems 511′, 513′, 515′, and 517′, which are connected via network 521′.

Conference room systems 511′, 513′, 515′, and 517′ may each include a processor and memory (not shown). Conference room systems 511′, 513′, 515′, and 517′ may further include peripherals such as projection screens, projectors, speakers, microphones, cameras, keyboards, mice, etc. (not shown). Network 521′ may comprise a local access network (LAN), an intranet, the Internet, etc. Network 521′ may further connect to one or more conferencing servers, e.g., conference server 601 of FIG. 6, that manage the communications session between the plurality of participants.

In the example of FIG. 5B, the memories of conference room systems 511′, 513′, 515′, and 517′ include communications session software such that shared content 523′ is displayed to each participant. Shared content 523′ may be stored on one or more of conference room systems 511′, 513′, 515′, and 517′. Alternatively or concurrently, shared content 523′ may be stored on a remote server, e.g., cloud storage 103 of FIG. 1 (not shown in FIG. 5B).

In the example of FIG. 5B, example method 300 of FIG. 3 (and/or example method 400 of FIG. 4) is executed by the conference server. Accordingly, as depicted in FIG. 5B, notification 525′ is displayed on shared content 523′ for each participant. Although depicted as a visual modification to shared content 523′ in FIG. 5B, notification 525′ may alternatively or concurrently comprise a textual indication of a location on shared content 523′, a visual indication of a location on shared content 523′ yet separate therefrom, a sound, or a combination thereof.

Systems 500 and 500′ may be combined. For example, one or more of user interface devices 511, 513, 515, 517, and 519 and one or more of conference room systems 511′, 513′, 515′, and 517′ may be connected to the same conference session. Accordingly, in certain aspects, networks 521 and 521′ may be the same network and/or operably connected together. In such an example, shared content may therefore be shared between the one or more of user interface devices 511, 513, 515, 517, and 519 and the one or more of conference room systems 511′, 513′, 515′, and 517′ (or a subset thereof).

The disclosed systems and methods may be implemented on one or more computing devices. Such a computing device may be implemented in various forms including, but not limited to, a client, a server, a network device, a mobile device, a laptop computer, a desktop computer, a workstation computer, a personal digital assistant, a blade server, a mainframe computer, and other types of computers. The computing device described below and its components, including their connections, relationships, and functions, is meant to be an example only, and not meant to limit implementations of the systems and methods described in this specification. Other computing devices suitable for implementing the disclosed systems and methods may have different components, including components with different connections, relationships, and functions.

As explained above, FIG. 6 is a block diagram that illustrates an example conference server 601 suitable for implementing the disclosed systems and methods. Conference server 601 may reside on a single server farm or may be distributed across a plurality of server farms.

As depicted in FIG. 6, conference server 601 may include at least one processor (e.g., processor 603), at least one memory (e.g., memory 605), and at least one network interface controller (N IC) (e.g., NIC 607).

Processor 603 may comprise a central processing unit (CPU), a graphics processing unit (GPU), or other similar circuitry capable of performing one or more operations on a data stream. Processor 603 may be configured to execute instructions that may, for example, be stored on memory 605.

Memory 605 may be volatile memory (such as RAM or the like) or non-volatile memory (such as flash memory, a hard disk drive, or the like). As explained above, memory 605 may store instructions for execution by processor 603.

NIC 607 may be configured to facilitate communication with conference server 601 over at least one computing network (e.g., network 609). Communication functions may thus be facilitated through one or more NICs, which may be wireless and/or wired and may include an Ethernet port, radio frequency receivers and transmitters, and/or optical (e.g., infrared) receivers and transmitters. The specific design and implementation of the one or more NICs depend on the computing network 609 over which conference server 601 is intended to operate. For example, in some embodiments, conference server 601 may include one or more wireless and/or wired NICs designed to operate over a GSM network, a GPRS network, an EDGE network, a Wi-Fi or WiMax network, and a Bluetooth® network. Alternatively or concurrently, conference server 601 may include one or more wireless and/or wired NICs designed to operate over a TCP/IP network.

Processor 603, memory 605, and/or NIC 607 may comprise separate components or may be integrated in one or more integrated circuits. The various components in conference server 601 may be coupled by one or more communication buses or signal lines (not shown).

As further depicted in FIG. 6, conference server 601 may include an email interface 611 configured to communicate with email server 613. Although depicted as separate in FIG. 6, email interface 611 may, in whole or in part, be integrated with NIC 607.

As depicted in FIG. 6, conference server 601 may include and/or be operably connected to a database 615 and/or a storage device 617. Database 615 may represent a relational database, object database, document database, or other digital database, which may be stored, in whole or in part, on conference server 601 and/or, in whole or in part, on a separate server (e.g., cloud storage 103 of FIG. 1). Storage device 617 may be volatile (such as RAM or the like) or non-volatile (such as flash memory, a hard disk drive, or the like).

I/O module 619 may enable communications between processor 603 and memory 605, database 615, and/or storage device 617.

As depicted in FIG. 6, memory 605 may store one or more programs 621. For example, programs 621 may include one or more server applications 623, such as applications that facilitate graphic user interface processing, facilitate communications sessions using NIC 607, facilitate exchanges with email server 613, or the like. By way of further example, programs 621 may include an operating system 625, such as DRAWIN, RTXC, LINUX, iOS, UNIX, OS X, WINDOWS, or an embedded operating system such as VXWorkS. Operating system 625 may include instructions for handling basic system services and for performing hardware dependent tasks. In some implementations, operating system 625 may comprise a kernel (e.g., UNIX kernel). Memory 605 may further store data 621, which may be computed results from one or more programs 621, data received from NIC 607, data retrieved from database 615 and/or storage device 617, and/or the like.

Each of the above identified instructions and applications may correspond to a set of instructions for performing one or more functions described above. These instructions need not be implemented as separate software programs, procedures, or modules. Memory 605 may include additional instructions or fewer instructions. Furthermore, various functions of conference server 601 may be implemented in hardware and/or in software, including in one or more signal processing and/or application specific integrated circuits.

The foregoing description has been presented for purposes of illustration. It is not exhaustive and is not limited to precise forms or embodiments disclosed. Modifications and adaptations of the embodiments will be apparent from consideration of the specification and practice of the disclosed embodiments. For example, the described implementations include hardware and software, but systems and methods consistent with the present disclosure can be implemented with hardware alone. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations and/or alterations based on the present disclosure. The elements in the claims are to be interpreted broadly based on the language employed in the claims and not limited to examples described in the present specification or during the prosecution of the application, which examples are to be construed as nonexclusive.

Instructions or operational steps stored by a computer-readable medium may be in the form of computer programs, program modules, or codes. As described herein, computer programs, program modules, and code based on the written description of this specification, such as those used by the processor, are readily within the purview of a software developer. The computer programs, program modules, or code can be created using a variety of programming techniques. For example, they can be designed in or by means of Java, C, C++, assembly language, or any such programming languages. One or more of such programs, modules, or code can be integrated into a device system or existing communications software. The programs, modules, or code can also be implemented or replicated as firmware or circuit logic.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

Other embodiments will be apparent from consideration of the specification and practice of the embodiments disclosed herein. It is intended that the specification and examples be considered as example only, with a true scope and spirit of the disclosed embodiments being indicated by the following claims.

1. A system for enabling participants in a communications session having shared content to express an interest in the shared content, the system comprising:
at least one memory storing instructions; and
at least one processor configured to execute the instructions to:
store shared content,
send the shared content to at least one of the participants in the communications session,
receive, from at least one participant in the communications session, an indication that the participant has expressed interest in the shared content,
determine a location on the shared content associated with the received indication, and
modify the shared content to include a visual indicator incorporated into the shared content at the determined location and send the modified shared content to at least one other participant.

2. The system of claim 1, wherein the at least one processor is further configured to receive at least one set of coordinates local to a screen associated with the participant.

3. The system of claim 2, wherein the instructions to determine the location further comprise instructions to convert the local set of coordinates to a global set of coordinates.

4. The system of claim 1, wherein the at least one processor is further configured to receive at least one image or cropped image representative of an area of interest of a screen associated with the participant.

5. The system of claim 4, wherein the instructions to determine the location further comprise instructions to extract the location from the at least one image.

6. (canceled)

7. The system of claim 1, wherein the shared content includes at least one image, and the instructions to modify the shared content further comprise instructions to modify the at least one image.

8. The system of claim 1, wherein the notification further comprises a sound.

9. The system of claim 1, wherein the indication is received using a network interface controller.

10. The system of claim 1, wherein the notification is sent using a network interface controller.

11. A method for enabling participants in a communications session having shared content to express an interest in the shared content, the method comprising:
storing shared content;
sending the shared content to at least one of the participants in the communications session;
receiving, from at least one participant in the communications session, an indication that the participant has expressed interest in the shared content;
determining a location on the shared content associated with the received indication; and
modifying the shared content to include a visual indicator incorporated into the shared content at the determined location and sending the modified shared content to at least one other participant.

12. The method of claim 11, further comprising receiving at least one set of coordinates local to a screen associated with the participant.

13. The method of claim 12, wherein determining the location further comprises converting the local set of coordinates to a global set of coordinates.

14. The method of claim 11, further comprising receiving at least one image or cropped image representative of an area of interest of a screen associated with the participant.

15. The method of claim 14, wherein determining the location further comprises extracting the location from the at least one image.

16. (canceled)

17. The method of claim 11, wherein the shared content includes at least one image, and modifying the shared content further comprises modifying the at least one image.

18. A non-transitory computer-readable medium storing instructions that, when executed by at least one processor, cause the at least one processor to:
store shared content;
send the shared content to at least one of the participants in the communications session;
receive, from at least one participant in the communications session, an indication that the participant has expressed interest in the shared content, determine a location on the shared content associated with the received indication, and
modify the shared content to include a visual indicator incorporated into the shared content at the determined location and send the modified shared content to at least one other participant.

19. The non-transitory medium of claim 18, wherein the instructions further cause the at least one processor to receive at least one set of coordinates local to a screen associated with the participant and convert the local set of coordinates to a global set of coordinates.

20. The non-transitory medium of claim 18, wherein the instructions further cause the at least one processor to receive at least one image or cropped image representative of an area of interest of a screen associated with the participant and extract the location from the at least one image.

21. The system of claim 1, wherein the at least one processor is further configured to:
receive a command, from at least one of a host and the participant, to clear the indication; and
revert the modified shared content to remove the indicator at the determined location and send the reverted shared content to the at least one of the other participants.

22. The system of claim 1, wherein the at least one processor is further configured to:
receive a second indication that a participant has expressed interest in the shared content,
determine a second location of the shared content associated with the received second indication, and
further modify the shared content to remove the indicator at the determined location and include an indicator at the determined second location and send the further modified shared content to the at least one of the other participants.

23. The system of claim 1, wherein:
the shared content is stored on a host independent of a device associated with the participant; and
the at least one processor is further configured to: send the shared content to the device associated with the participant and to send the modified shared content to the host and to the device associated with the participant.
